(19) United States
(12) Patent Application Publication
(10) Pub. No.: US 2007/0234636 A1
(43) Pub. Date: Oct. 11, 2007

(54) FISHING BOX WITH REMOVABLE DESICCANT CONTAINER

(76) Inventor: Steven S. Schwartz, Thornton, CO (US)

Correspondence Address: DORR, CARSON & BIRNEY, P.C.;ONE CHERRY CENTER, 501 SOUTH CHERRY STREET, SUITE 800, DENVER, CO, 80246, US

(21) Appl. No.: 11/687,777

(22) Filed: Mar. 19, 2007

Related U.S. Application Data
(60) Provisional application No. 60/790,162, filed on Apr. 7, 2006.

(51) Int. Cl. A01K 97/06

(52) U.S. Cl. 43/54.1; 206/315.11; 43/57.1

(57) ABSTRACT

A fishing box assembly includes a fishing box for storing lures and a removable desiccant container within the fishing box holding a desiccant material for adsorbing moisture from lures within the fishing box. Flies and lures can be placed inside the fishing box while they are still wet, and not incur the rust problems that heretofore existed. After a period of use, the desiccant container can be removed and replaced, or the desiccant can be regenerated for reuse.

### RELATED APPLICATION

The present application is based on and claims priority to the Applicant's U.S. Provisional Patent Application 60/790,162, entitled “Fishing Box With Removable Desiccant Container,” filed on Apr. 7, 2006.

### BACKGROUND OF THE INVENTION

Field of the Invention. The present invention relates generally to the field of fishing equipment. More specifically, the present invention discloses a fishing box with a removable desiccant container.

Statement of the Problem. Artificial flies are made of natural and synthetic fur and materials that absorb and retain a significant amount of water after being immersed for long periods of time. When fishing with artificial flies, anglers may use, change and replace many different patterns throughout the day. It is not uncommon to change 20 different flies or more in a day of fishing. After removing the wet fly from the fly line, some anglers dry the wet fly by placing it on small piece of fleece worn on the fishing vest or on the angler's hat. However, this carries a significant risk that the wet fly will fall off and become lost, particularly if the angler moves through brush.

Some anglers return wet flies directly to the fly box so that they will not become lost. However, wet flies can produce high moisture levels inside a fly box and cause hooks to rust and weaken. Prolonged high moisture levels can also weaken and deteriorate hackle, thread and tying materials over time. Large flies and streamers in particular can adsorb, retain, and generate a lot of moisture inside a fly box. This high amount of moisture can also affect other flies in the box in the same ways.

A similar problem exists with regard to other types of fishing boxes. Lures and other types of fishing tackle tend to rust or otherwise degrade when stored in a moist or humid environment. Therefore, a need exists for a means of drying flies and other types of fishing tackle, and preventing the accumulation of moisture within fishing boxes.

Solution to the Problem. The present invention provides a fishing box equipped with a number of removable desiccant containers holding a desiccant material that adsorbs moisture and humidity within the fishing box. For example, the desiccant container can be recessed inside the lid of the fishing box. In addition, the desiccant can include an indicator material that changes color as the desiccant adsorbs moisture (e.g., changing from orange to green). After adsorbing moisture, the desiccant container can be removed and heated (e.g., in a microwave oven) to restore the adsorption qualities of the desiccant material and return the indicator material to its original color (e.g., orange). This regeneration process can be repeated as needed over an extended period of time.

### SUMMARY OF THE INVENTION

This invention provides a fishing box with a desiccant container to adsorb moisture and humidity from flies and lures within the fishing box. Flies and lures can be placed inside the fishing box while they are still wet, and not incur the rust problems that heretofore existed. After a period of use, the desiccant container can be removed and replaced, or the desiccant can be regenerated for reuse.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a perspective view of a fishing box 10 with a removable desiccant container 20.

FIG. 2 is a corresponding cross-sectional view of the fishing box 10 and desiccant container 20 with the lid of the fishing box closed.

FIG. 3 is an exploded perspective view of the desiccant container 20.

FIG. 4 is a cross-sectional view of the lid of a fishing box 10 in another embodiment in which the foam pad 12 has lips 13 to retain the desiccant container 20 in place.

FIG. 5 is a cross-sectional view of the lid of a fishing box 10 in another embodiment in which clips 17 are used to retain the desiccant container 20 in place.

FIG. 6 is a perspective view of a larger fishing box 10 with a series of compartments for storing lures 15 and four desiccant containers 20 attached to the lid of the fishing box 10.

FIG. 7 is a cross-sectional view of the larger fishing box 10 in FIG. 6 with its lid closed.

FIG. 8 is a perspective view of a fishing box 10 with multiple compartments for storing lures 15, and a desiccant container 20 inside the lid of the fishing box 10 that closes over one of the storage compartments 18.

FIG. 9 is a cross-sectional view of the fishing box 10 in FIG. 8 with its lid closed.

### DETAILED DESCRIPTION OF THE INVENTION

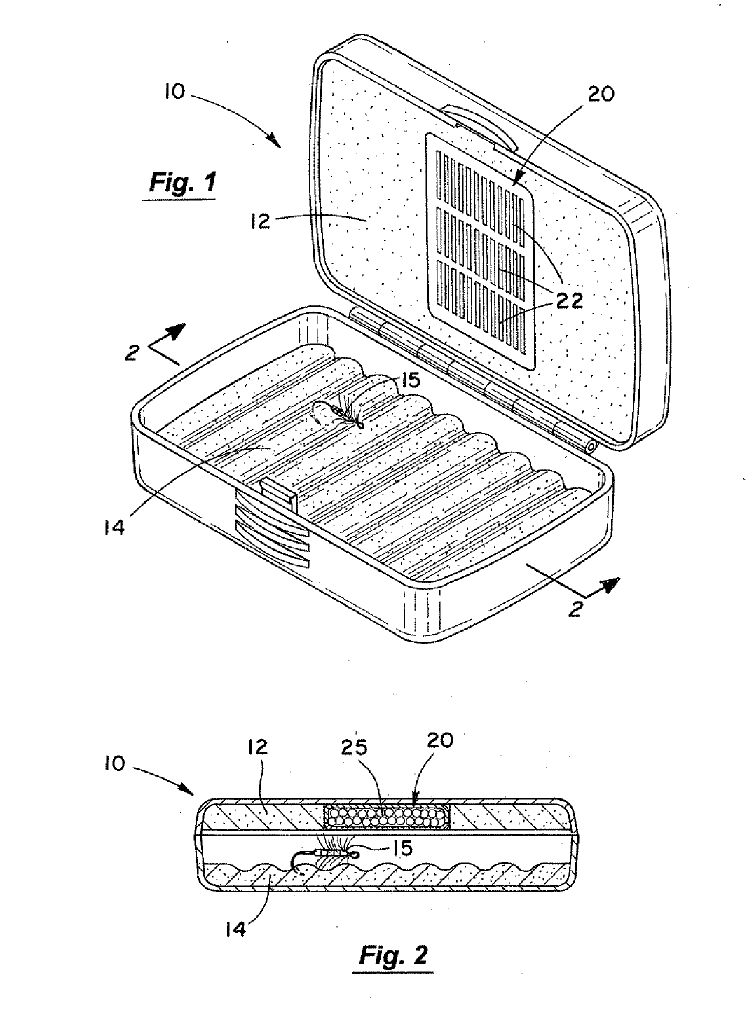

Turning to FIG. 1, a perspective view is shown of one embodiment of the present invention. The major components are a fishing box 10 and a removable desiccant container 20. FIG. 2 is a corresponding cross-sectional view of the fishing box 10 and desiccant container 20 with the lid of the fishing box closed. FIGS. 1 and 2 depict a typical fly box 10 used to store flies 15 for fly fishing or lures. For the purposes of this application, both flies and lures should be interpreted as falling within the definition of the word “lure.”

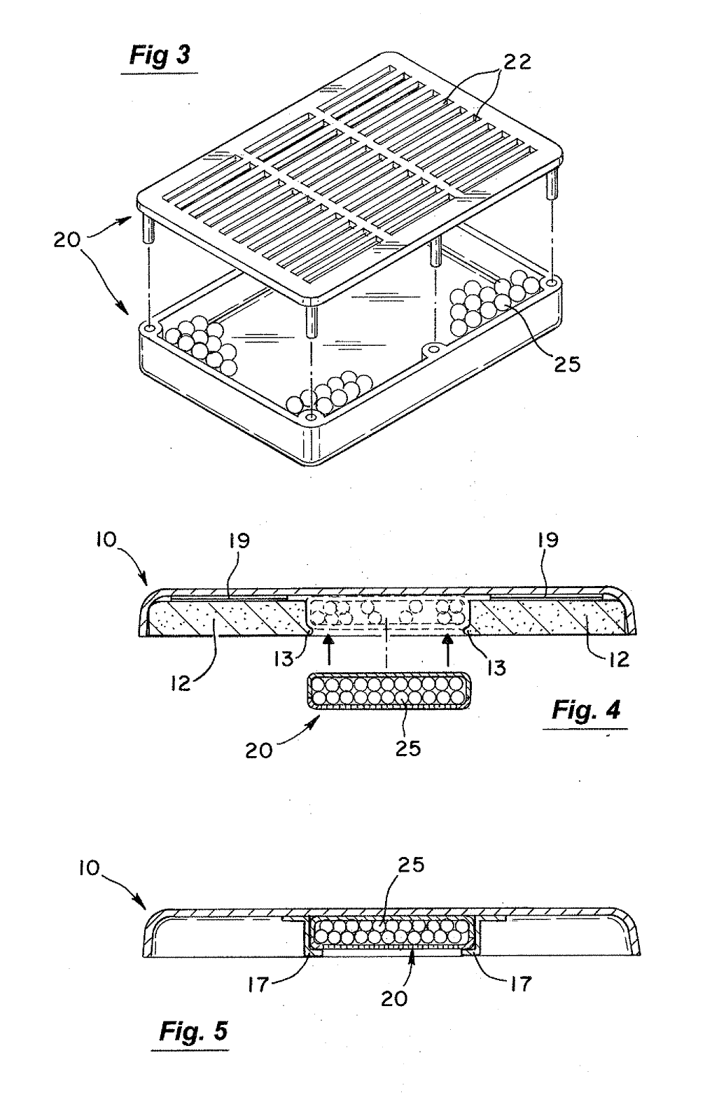

FIG. 3 is an exploded perspective view of one embodiment of a desiccant container 20. The desiccant container 20 is an enclosure capable of holding desiccant material 25. For example, the desiccant container 20 can be generally rectangular with dimensions of about 3 by 2 by 7/16 inches in depth. The desiccant container 20 has a lid that snaps on after the desiccant has been placed inside. The desiccant container 20 is preferably made of a microwaveable plastic. The desiccant container includes a number of openings 22 through the walls of the desiccant container. These openings 22 enable moisture in the fishing box 10 to reach the desiccant 25 inside the desiccant container 20. The openings 22 also allow water vapor to escape the desiccant container 10 during the regeneration process, as will be described below. Optionally, small plastic feet can be placed on the bottom of the desiccant container 20. These feet elevate the desiccant container 20 in a microwave oven to allow water vapor to escape from the bottom of the desiccant container 20 as well.

Over a period of time, the desiccant material 25 gradually adsorbs moisture from the air and eventually approaches saturation. As this occurs, the desiccant material will become less effective in removing additional moisture. At some point, perhaps dictated by the saturation color change of the desiccant, the user removes the desiccant container 20 from the fishing box and regenerates the desiccant material 25. Many desiccants can be regenerated by heating to drive off moisture for reuse (e.g., in a microwave oven). Alternatively, the desiccant container 20 could be disposable. In that case, the user would need to purchase a replacement desiccant container 20.

Any of a wide variety of desiccant materials 25 can be used. For example, silica gel performs best when used in applications where humidity levels are between 60% to 90%. Much like a sponge, silica gel attracts and holds water equal to about 40% of its weight. Silica gel is commercially available in beads, granules, crystals or powdered form. The preferred embodiment uses round beads of silica gel impregnated with an indicator material (e.g., a dye) that changes color to indicate the level of moisture adsorption remaining in a given sample. For example, desiccant material of this type are commercially available from the following suppliers: (1) Delta Adsorbents Company, 24 Congress Circle, Roselle, Ill. 60172 (“Sorbead Orange”); (2) Sphinx Adsorbents, Inc., 53 Progress Ave, Springfield, Mass. 01104 (Product code: “Type C, Grade 10Y”); (3) Impak Corporation, 2460 E. 57th Street, Los Angeles, Calif. 90058; or (4) AGM Container Controls, Inc., 3526 E. Fort Lowell Road, Tucson, Ariz. 85717.

Other possible desiccant materials include clay desiccants, zeolites or activated alumina. These desiccant materials could take the form of packets, canisters, woven bags, or small woven bags with one side of packet with a clear plastic covering in order to see the indicating color of the desiccant within. It is also possible that the desiccant can be molded into parts or shapes (squares, circles, rectangles, other geometric shapes) either by itself in natural form, or mixed with a substance that will strengthen and allow geometric shaping.

The desiccant container 20 can be held in place within the fishing box 10 by a variety of means. The embodiment shown in FIGS. 1 and 2 has foam pads 12 and 14 in the lid and base of the fly box 10 that are suitable for storing flies 15 in the conventional manner. The foam pads 12, 14 can be glued or otherwise attached to the lid and base of the fishing box 10. For example, the desiccant container 20 can be set into, or attached to the foam pad 12 in the lid of the fishing box 10. However, it should be understood that the desiccant container 20 in this embodiment could be placed anywhere in the foam pad 12 in the lid, or set anywhere in the foam pad 14 in the base of the fly box 10. In particular, a recess or cut-out is formed in the foam pad 12 to hold the desiccant container 20 by a frictional fit. This is sufficient to hold the desiccant container 20 in place during normal use of the fly box 10, but allows the desiccant container 20 to be easily removed for inspection, regeneration or replacement. In a small fishing box 10, a single desiccant container 20 can be set in the center of the lid as shown in FIGS. I and 2, to draw moisture from all areas within the fishing box 10. Alternatively, multiple desiccant containers 20 can be employed to deal with humidity in a larger fishing box 10.

FIG. 4 is a cross-sectional view of the lid of a fly box 10 showing a second embodiment in which lips or a rim 13 in the pad 12 hold the desiccant container 20 in place. Hook-and-loop fasteners 19 or adhesive hold the pad 12 in place in the lid of the fly box 10. In this embodiment, the foam pad 12 has a cavity formed into the foam with lips or a rim 13 to retain the desiccant container 20 in the cavity. The entire foam pad 12 can be removable to allow the desiccant container 20 to be placed into the cavity of the pad 12, after which the foam pad 12 is secured with hook-and-loop fasteners 19 to the lid of the fishing box 10. Alternatively, the desiccant container 20 could be directly inserted through the cavity opening as shown in FIG. 4.

FIG. 5 is a cross-sectional view of the lid of a fishing box 10 in another embodiment in which clips 17 are used to retain the desiccant container 20 in place. Alternatively, the desiccant container 20 could be held in place by hook-and-loop fasteners, snaps, straps, adhesive or other means for removably securing it inside the fishing box 10. In other embodiments, the desiccant material 25 can be housed in a permanent compartment in the fishing box 10, whereby the compartment itself or a container within the compartment could pop out to be regenerated. This type of compartment should be considered to be within the scope a “desiccant container” for the purposes of this invention.

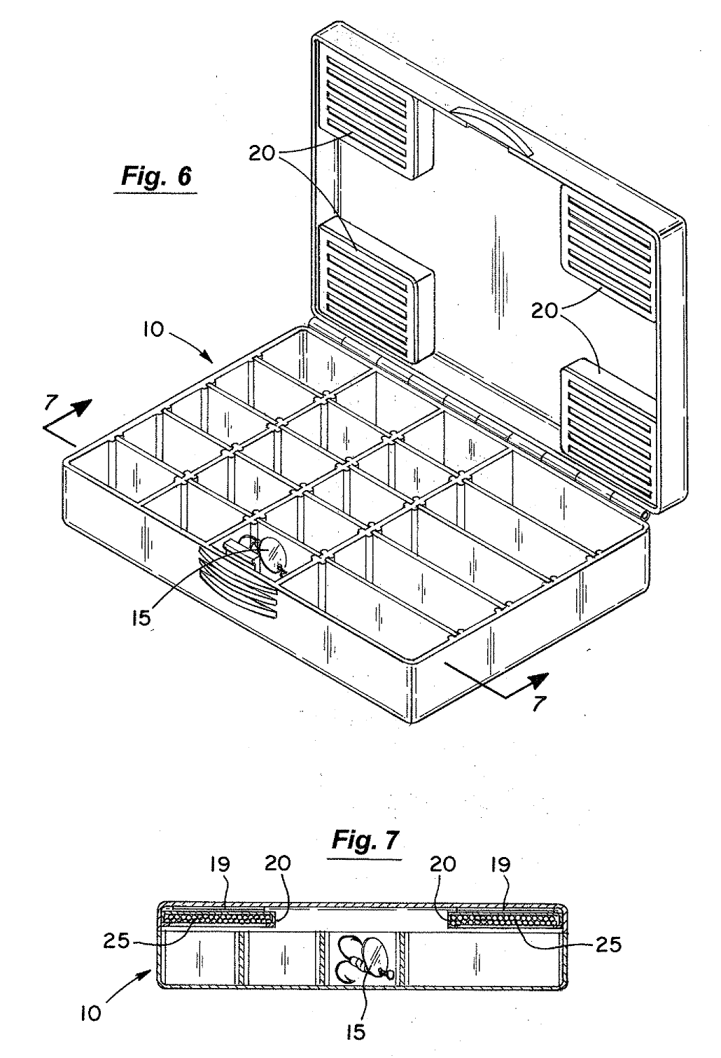

It should also be understood that any type of fishing box 10 could be used. The fishing box can have any desired dimensions or configuration, and can be made of any suitable materials. FIG. 6 is a perspective view of a larger fishing box 10 with an array of compartments for storing lures 15 and a number of desiccant containers 20 attached inside the lid of the fishing box 10. FIG. 7 is a cross-sectional view of the larger fishing box 10 in FIG. 6 with its lid closed. When the lid closes, each desiccant container 20 is positioned over one or more compartments to provide localized drying for specific compartments, or there could be a small gap when closed so that air can move between the compartments. This enables the user to choose a compartment for storage of a lure 15 based on the color of the desiccant in a particular compartments desiccant container 20.

The present invention could also be implemented in fishing boxes having multiple layers of stackable compartments or trays. A number of desiccant containers 20 could be attached to the lid, bottom or sides of the interior of the fishing box.

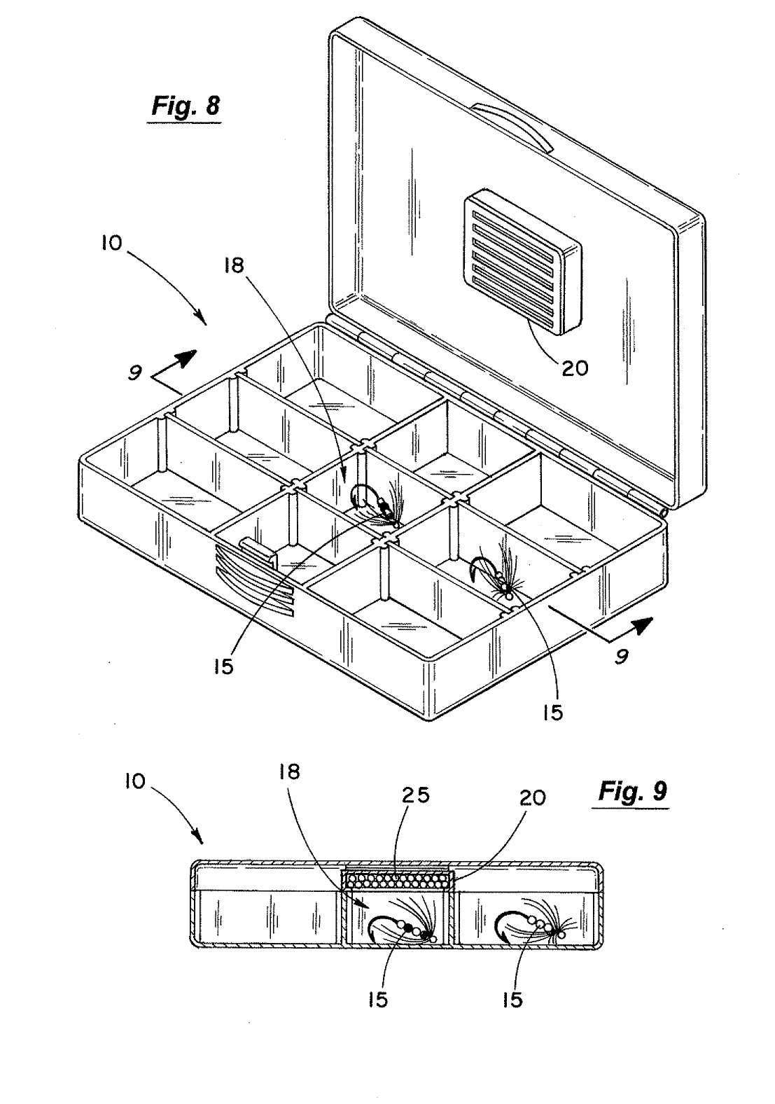

FIG. 8 shows an embodiment of a fishing box 10 with multiple compartments for storing lures 15, and a desiccant container 20 inside the lid of the fishing box 10 that closes over one of the storage compartments 18. FIG. 9 is a cross-sectional view of the fishing box 10 in FIG. 8 with the lid closed. In this closed position, the desiccant container 20 covers the top of this storage compartment 18 so that lures 15 within the compartment 18 are dried by the desiccant. In contrast, the remaining storage compartments in the base of the fishing box 10 receive relatively little or no drying by the desiccant depending on the extent that air flow is permitted between the lower surface of the desiccant container 20 and the top of the central storage compartment 18. Alternatively, the desiccant container 20 could be designed to cover a plurality of drying storage compartments.

It is envisioned that the embodiment should in FIGS. 8 and 9 could be used in the following manner. Prior to fishing, all of the lures 15 are typically dry, and therefore do not need to be held in the drying storage compartment 18 beneath the desiccant container 20. Rather, these dry lures 15 can be stored in any of the storage compartments surrounding the drying storage compartment 18 in FIG. 8. As individual lures 15 are used sequentially in fishing, they become wet and are then retired to the drying storage compartment 18 in the fishing box 10. Thus, the desiccant is used optimally to dry only the wet lures 15, with only minimal exposure to moisture in the ambient air. This lengthens the effective life of the desiccant and increases its effectiveness in drying wet lures.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A fishing box assembly comprising:
a fishing box for storing lures; and
a removable desiccant container within the fishing box holding a desiccant material for adsorbing moisture within the fishing box.

2. The fishing box assembly of claim 1 wherein the desiccant material is impregnated with an indicator material that changes color to indicate the level of moisture adsorption.

3. The fishing box assembly of claim 1 wherein the desiccant material can be regenerated by heating the desiccant container.

4. The fishing box assembly of claim 1 wherein the fishing box further comprises:
a base divided into a plurality of storage compartments for holding lures; and
a lid removably covering the base, wherein the desiccant container is removably attached to the interior of the lid.

5. The fishing box assembly of claim 4 wherein the desiccant container is positioned over at least one selected storage compartment when the lid is closed.

6. The fishing box assembly of claim 1 wherein the fishing box further comprises:
a base for holding lures;
a lid removably covering the base; and
a pad attached to the interior of the lid having a cavity to retain the desiccant container.

7. A fishing box assembly comprising:
a fishing box for storing lures;
a pad attached within the fishing box and having a cavity; and
a desiccant container within the fishing box holding a desiccant material for adsorbing moisture within the fishing box, said desiccant container being removably held within the cavity of the pad.

8. The fishing box assembly of claim 7 wherein the desiccant material is impregnated with an indicator material that changes color to indicate the level of moisture adsorption.

9. The fishing box assembly of claim 7 wherein the desiccant material can be regenerated by heating the desiccant container.

10. The fishing box assembly of claim 7 wherein the fishing box further comprises:
a base divided into a plurality of storage compartments for holding lures; and
a lid removably covering the base, wherein the pad and desiccant container are attached to the interior of the lid.

11. The fishing box assembly of claim 10 wherein the desiccant container is positioned over at least one storage compartment when the lid is closed.

12. A fishing box assembly comprising:
a fishing box having a base divided into a plurality of storage compartments for holding lures and a lid removably covering the base; and
a removable desiccant container removably attached to the interior of the lid holding a desiccant material for adsorbing moisture within the fishing box, wherein the desiccant container is positioned over at least one storage compartment when the lid is closed.

13. The fishing box assembly of claim 12 wherein the desiccant material is impregnated with an indicator material that changes color to indicate the level of moisture adsorption.

14. The fishing box assembly of claim 12 wherein the desiccant material can be regenerated by heating the desiccant container.

15. The fishing box assembly of claim 12 further comprising a pad attached to the interior of the lid having a cavity to retain the desiccant container.
